(19) United States
(12) Patent Application Publication
(10) Pub. No.: US 2005/0040558 A1
(43) Pub. Date: Feb. 24, 2005

(54) Method and assembly for over-moulding a tubular element by plastic material compression

(76) Inventor: Laurent Baudart, Meru (FR)

Correspondence Address: YOUNG & THOMPSON, 745 SOUTH 23RD STREET, 2ND FLOOR, ARLINGTON, VA, 22202, US

(21) Appl. No.: 10/495,137

(22) PCT Filed: Nov. 8, 2002
(86) PCT No.: PCT/FR02/03853

(30) Foreign Application Priority Data
Nov. 8, 2001 (FR) 01/14456

(51) Int. Cl. B29C 43/18

(52) U.S. Cl. 264/259; 264/314; 425/387.1

(57) ABSTRACT

The invention concerns a method and an assembly for over-moulding an at least partially tubular element by plastic material compression. Said tubular element has an inner surface (22a) and extends along a elongation direction (8). The invention is characterized in that the method comprises the following steps: a) using a mechanical device (6) extending between a proximal end and a free end, and having a rigidity such that it extends in its radially restricted state along a substantially rectilinear axial direction (8) and said shape is self-maintained. b) placing the mechanical device in its radially restricted state, c) maintaining the mechanical device by its proximal end and inserting the mechanical device inside the tubular element by translation along said elongation direction, d) bringing the mechanical device in its radially expanded state, e) closing said mould for compressing the plastic material.

The invention relates to a method and an assembly for over-moulding an at least partially tubular element by compression of plastics material.

Over-moulding an element subjects the element to very high stresses owing to the pressure necessary in order to obtain a satisfactory distribution of the material in the mould and the poor fluidity of the plastics material. Hollow elements, in particular tubular elements, have difficulty in withstanding very high stresses without undergoing permanent deformation.

Although reference is made only to the compression of plastics material, the invention is not limited to this moulding technique alone. It also relates to over-moulding by injection and compression or any other moulding technique which includes a step for compressing the material.

In order to solve this problem, WO-A-01 05570 discloses a technique which consists in particular in a non-compressible fluid being injected into the element to be over-moulded. However, this solution is not completely satisfactory to the extent that it is quite often difficult to retain the fluid at the desired location, in particular when the element to be over-moulded has holes.

It is further proposed in WO-A-99 25531 to introduce rubber-like material into the element to be over-moulded. This solution significantly complicates the production method to the extent that it is necessary in addition to control the supply of rubber-like material and, in particular, the recovery of this material from inside the element after over-moulding.

In order to solve the above-mentioned problems and to allow tubular elements of great length (approximately 1 metre and a length/diameter relationship of greater than 10) to be over-moulded, the invention proposes a method comprising the following steps within the field of over-moulding of a tubular element having an inner surface and extending in an extension direction:
a) using a mechanical device which extends between a proximal end and a free end and which has a radially restricted state and a radially expanded state, the device having a rigidity such that it extends in the radially restricted state thereof in a substantially rectilinear axial direction and keeps this shape of itself,
b) bringing the mechanical device into the radially restricted state thereof, in which it has a cross-section smaller than that of the inner surface of the tubular element,
c) securing the mechanical device at the proximal end thereof and introducing the mechanical device inside the tubular element by translation in the extension direction,
d) bringing the mechanical device, in the radially expanded state thereof, into contact, under pressure, with the inner surface of the tubular element,
e) after the mechanical device, the tubular element and the plastics material have been arranged inside a mould, closing the mould in order to compress the plastics material.

The use of such a mechanical device allows some of the stresses to which the element to be over-moulded is subjected to be supported in order to prevent any damage thereto. It can be used, including when the element has radial holes which are distributed in the extension direction. It is not necessary to control fluid flows or additional material and can readily be withdrawn from the element after over-moulding. Consequently, the solution of the invention is simple and easy to carry out.

Furthermore, it is particularly suitable for over-moulding a tubular element of great length because it keeps of itself substantially the rectilinear shape thereof, including when it is held only at one end.

According to a first embodiment, the invention proposes that:
the mechanical device is provided with a structure comprising reinforcing strands, a hermetic casing and means for supplying the casing with pressurised fluid,
during step d), the pressurised fluid is introduced into the hermetic casing.

This solution is simple and relatively light. The concept thereof, similar to that of a car tyre, ensures great strength.

According to a second embodiment, the invention proposes that:
the mechanical device is provided with a hermetic casing which surrounds a shaft and means for supplying the casing with pressurised fluid,
during step d), the pressurised fluid is introduced into the hermetic casing.

This solution is simple and relatively easy to carry out. The fluid is enclosed within the casing and can circulate in a closed circuit inside the device.

According to a third embodiment, the invention proposes that:
the device is provided with annular means which are radially expansible resiliently under the action of an axial stress and means for axially compressing the annular means,
during step d), the annular means are axially compressed.

Since an axial stress is relatively simple to obtain mechanically, this solution is also relatively easy to carry out.

According to a fourth embodiment, the invention proposes that:
the device is provided with radially movable elements which have a circular cross-section, such as spheres or cylinders having a circular cross-section, and which are arranged in an annular arrangement having an annular passage,
the device is provided with a rod having a cross-section greater than the cross-section of the annular passage when the device is in the radially restricted state thereof, and
during step d), the rod is engaged in the annular passage in order to displace the circular elements radially.

The use of elements having a circular cross-section leads to point-like or linear contacts, which reduces friction and facilitates the use of this device.

The invention further proposes that:
the tubular element has a first opening and a second opening which are arranged at each end of the tubular element in the extension direction and,
during step c), a first mechanical device is introduced through the first opening by translation in the extension direction, with the device being secured at the proximal end thereof, and a second mechanical device is introduced through the second opening by translation in the extension direction, with the device also being secured at the proximal end thereof.

The use of two mechanical devices accordingly reduces the length by which it is necessary to displace the device in the extension direction, which reduces the operating time and increases the reliability.

The invention further relates to an assembly for over-moulding an at least partially tubular element, which has an inner surface and which extends in an extension direction, by compression of plastics material, the assembly comprising a mould and a mechanical device which extends between a proximal end and a free end and which has a radially restricted state and a radially expanded state, the device having, in the radially restricted state thereof, a cross-section which is smaller than that of the inner surface of the tubular element and, in the radially expanded state thereof, a cross-section greater than or equal to that of the inner surface of the tubular element.

In order to solve the above-mentioned problems, the invention proposes that:
the mechanical device has a rigidity such that it extends in a substantially rectilinear axial direction between the proximal end and the free end, and keeps this shape of itself,
the assembly comprises means for displacing the mechanical device in the extension direction, the means securing the mechanical device only at the proximal end thereof.

In addition, the invention proposes that the assembly further comprises:
annular means of elastomer material which are radially expansible resiliently under the action of an axial stress and which have an outer surface which is completely cylindrical when the mechanical device is in the radially expanded state thereof and slightly concave when the mechanical device is in the radially restricted state thereof and
means for axially compressing the annular means.

A more effective support of the tubular element is obtained to the extent that it is very difficult to obtain radially expansible annular means which keep a cylindrical shape for different axial compressions, with the radially expanded state of the device being given priority.

As an alternative, the invention proposes that the assembly further comprises:
annular means which are radially expansible resiliently under the action of an axial stress, the annular means comprising a split ring and a sleeve having radially a cross-section forming a truncated cone, both being of metal, and
means for axially compressing the annular means so that the sleeve comes into contact with the ring, is inserted under the split ring and opens it.

In this manner, the assembly is particularly strong.

The invention will be appreciated even more clearly from the description below, given with reference to the appended drawings, in which:

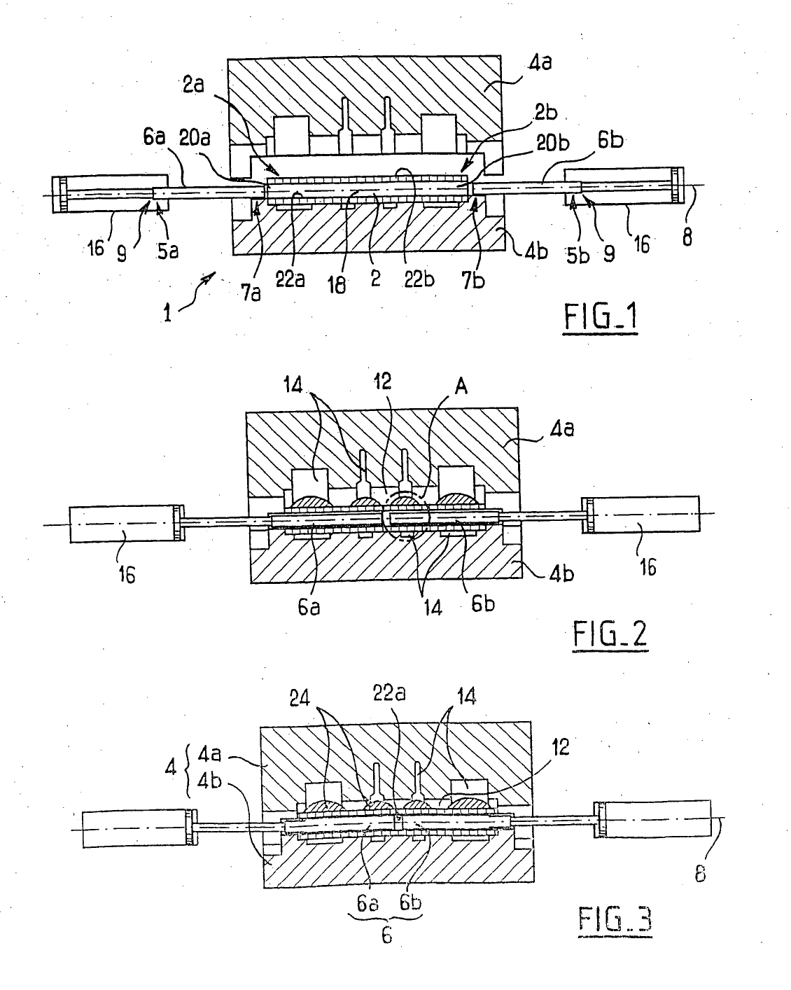

FIGS. 1 to 3 illustrate three successive steps of a method according to the invention,

FIG. 4 illustrates a first mechanical device according to the invention, drawn to an enlarged scale, in a radially restricted state, in the zone indicated A in FIG. 2,

FIG. 5 illustrates the device of FIG. 4 in a radially expanded state,

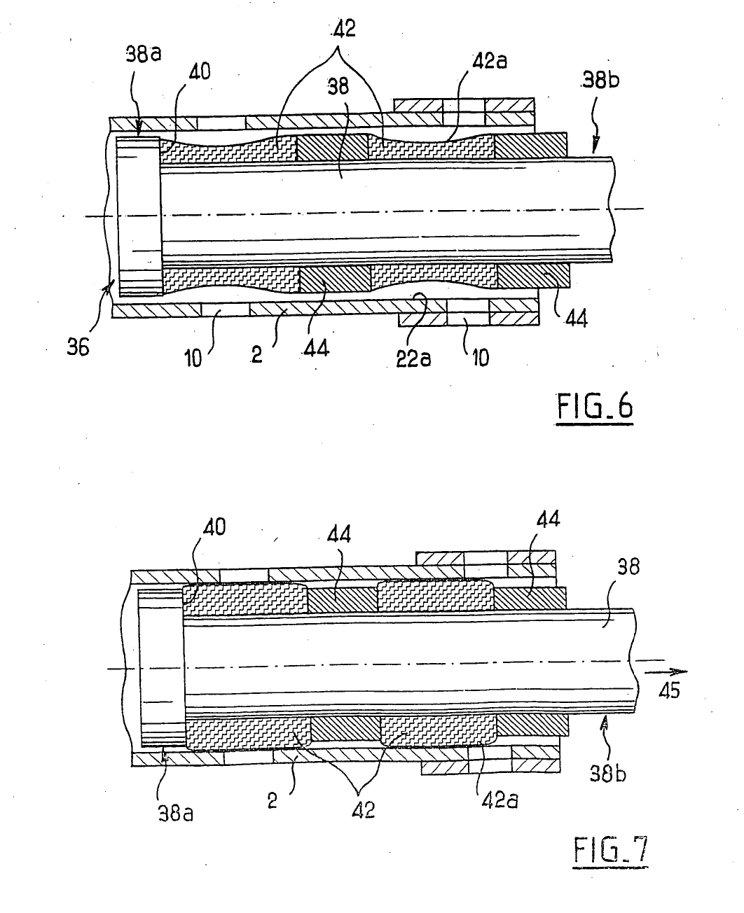

FIG. 6 shows a second mechanical device according to the invention, drawn to an enlarged scale, in a radially restricted state, in the zone indicated A in FIG. 2,

FIG. 7 shows the device of FIG. 6 in a radially expanded state,

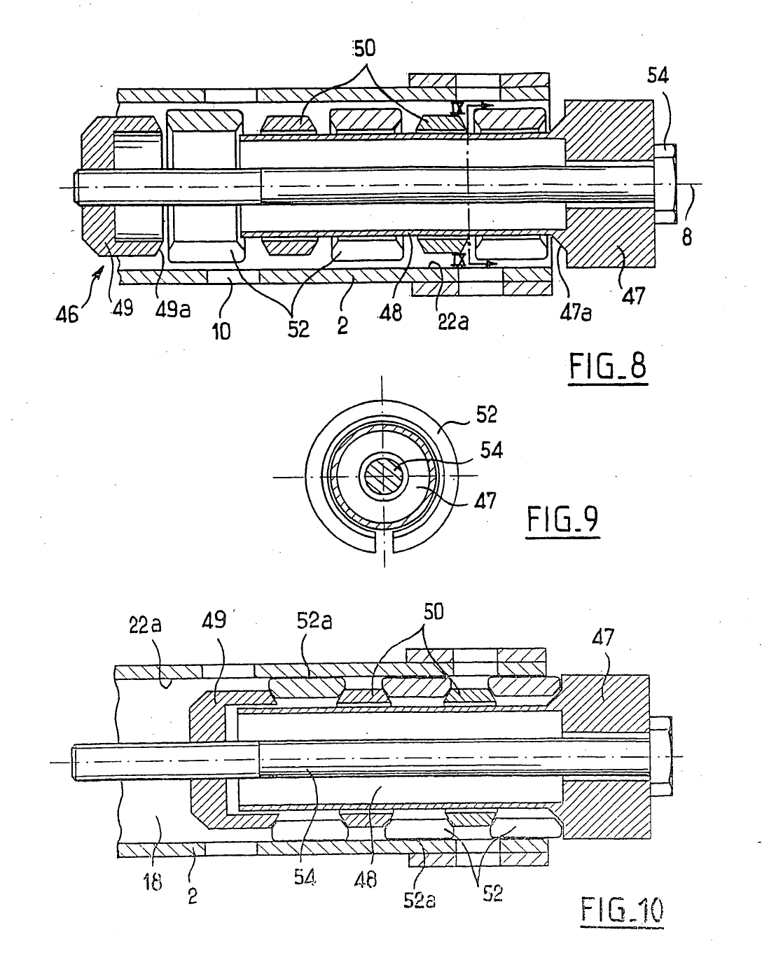

FIG. 8 shows a third mechanical device according to the invention, drawn to an enlarged scale, in a radially restricted state, in the zone indicated A in FIG. 2,

FIG. 9 is a view along line IX-IX of FIG. 8,

FIG. 10 shows the device of FIG. 8 in a radially expanded state,

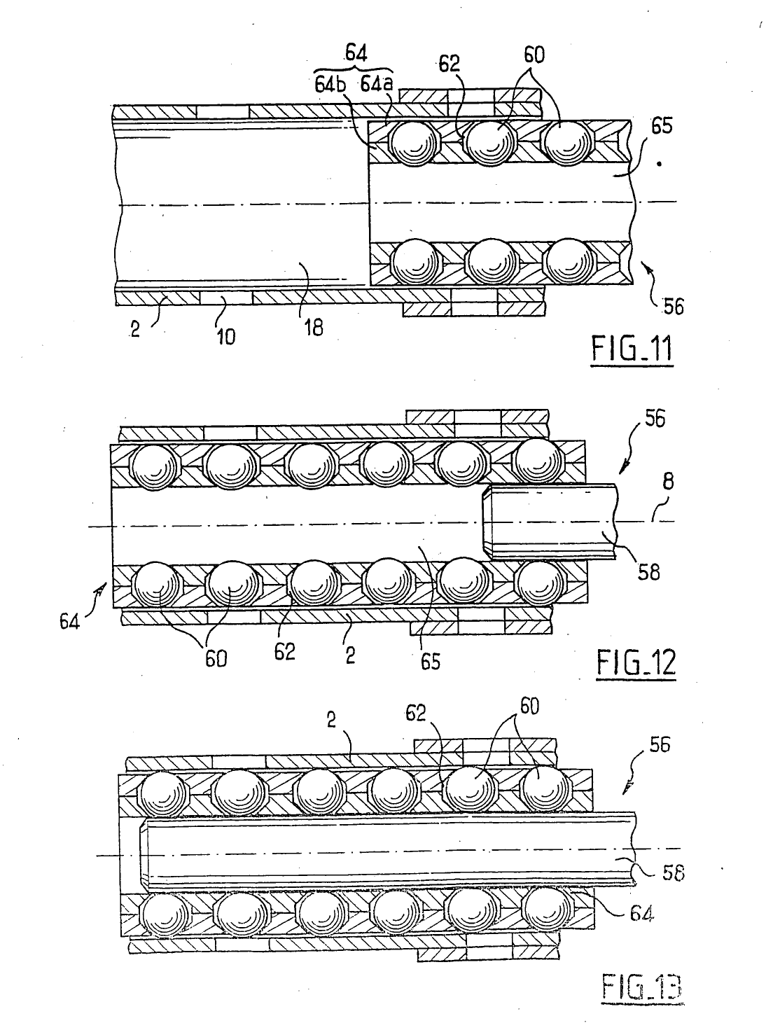

FIG. 11 shows a fourth mechanical device according to the invention, drawn to an enlarged scale, being introduced inside a tubular element, in the zone indicated A in FIG. 2,

FIG. 12 shows the fourth device in a substantially radially restricted state,

FIG. 13 shows the fourth device in a radially expanded state,

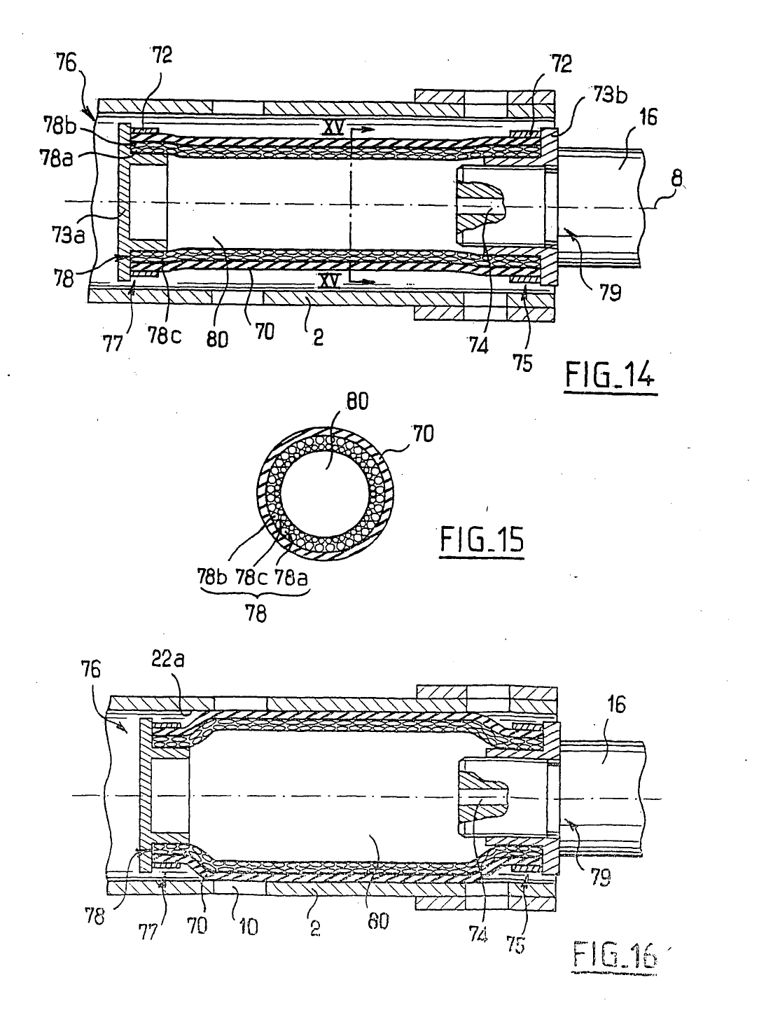

FIG. 14 shows a fifth mechanical device according to the invention, drawn to an enlarged scale, in a radially restricted state, in the zone indicated A in FIG. 2,

FIG. 15 is a view along line XV-XV of FIG. 14,

FIG. 16 shows the device of FIG. 14 in a radially expanded state.

FIGS. 1 to 3 are cross-sections of an assembly 1 for over-moulding a tubular element 2 which is constituted here by a motor vehicle cross-beam. The assembly 1 substantially comprises a mould 4 which comprises a bottom die 4a and an upper die 4b and a mechanical device 6 which comprises two substantially identical components 6a, 6b.

The cross-beam 2 extends in an extension direction 8 between two ends 2a, 2b. It has a passage 18 having a substantially constant cross-section in the extension direction and which terminates at each end 2a, 2b in an opening 20a, 20b. The passage 18 is delimited by an inner surface 22a. The cross-beam further comprises an outer surface 22b. Through-holes 10 extend radially (see FIGS. 4 to 13) between the inner surface 22a and the outer surface 22b.

The mould 4 has a main cavity 12 which is intended to receive the cross-beam 2 and secondary cavities 14 which communicate with the main cavity 12 and which are intended for moulding supports of plastics material around the cross-beam 2 and which are arranged from place to place in the extension direction 8. The mould further comprises functional cavities which extend between some of the secondary cavities in order to produce functional elements which are connected to the cross-beam 2 by the supports. However, since these functional cavities extend between the bottom die 4a and the upper die 4b outside the plane of section of FIGS. 1 to 3, they are not visible in these Figures.

Each component 6a, 6b of the mechanical device has an axial direction which is substantially aligned with the extension direction 8 of the cross-beam 2. Each component 6a, 6b extends between a proximal end 5a, 5b and a free end 7a, 7b, respectively. Each component 6a, 6b is secured in an overhanging state at the proximal end 5a, 5b thereof on a jack 16a, 16b by fixing means 9 in order to displace the corresponding portion of the device in the extension direction 8.

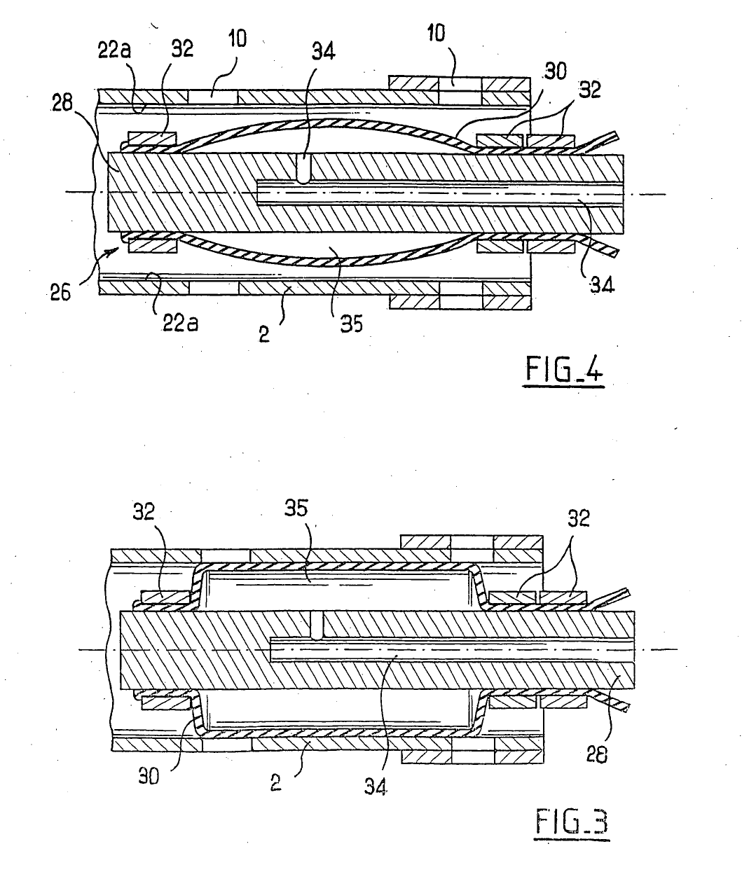

The device 6 has a radially restricted state, illustrated in FIGS. 1, 2, 4, 6, 8, 11 and 14, wherein it has a cross-section smaller than that of the inner surface 22a of the cross-beam and a radially expanded state, illustrated in FIGS. 3, 5, 7, 10, 13 and 16, wherein it has a cross-section greater than or equal to that of the inner surface 22a of the cross-beam, in order to come into contact therewith under pressure.

In order to carry out the over-moulding of the cross-beam 2, the cross-beam 2 is arranged in the main cavity 12 after the bottom die 4a and the upper die 4b have been removed.

Next, each component 6a, 6b of the mechanical device 6 is introduced through the corresponding opening 20a, 20b of the cross-beam by translation in the axial direction 8.

Plastics material 24 is then introduced into the secondary cavities 14, the device 6 is brought into the radially expanded state thereof and the plastics material is distributed in the secondary cavities 14, by means of compression, with the mould being closed by the bottom die 4a and the upper die 4b being brought together.

The order in which the plastics material 24 is introduced into the secondary cavities 14, the closure of the mould 4 is begun and the mechanical device 6 is brought into the radially expanded state thereof is relatively unimportant insofar as the mechanical device 6 is brought into the radially expanded state thereof before the plastics material applies a very high pressure to the cross-beam 2 owing to the compression applied by the closure of the mould 4.

By way of simplification, it appears in FIGS. 1 to 3 that the plastics material 24 has been introduced into the secondary cavities 24 near the cross-beam 2. However, the invention also applies to the case in which the plastics material is introduced partially or totally with spacing from the cross-beam 2 and, in particular, into the above-mentioned functional cavities, and comes into contact with this cross-beam only when the mould 4 is almost completely closed.

When the mould 4 is completely closed, the bottom die 4a being in contact with the upper die 4b, after cooling of the plastics material, the mechanical device 6 is brought into the radially restricted state thereof, the mechanical device 6 is withdrawn from the passage 18 by means of the jacks 16, then the mould 4 is opened and the finished piece is removed with the supports of plastics material over-moulded on the cross-beam 2.

This method applies in particular to the case of plastics material which is filled with fibres, such as a stampable reinforced thermoplastic (TRE).

FIGS. 4 and 5 illustrate a mechanical device 26 comprising a shaft 28, around which a hermetic membrane 30 is secured by means of rings 32. The shaft 28 encloses a supply duct 34 for pressurised fluid, which duct opens into a space 35 which is located between the membrane 30 and the shaft 28.

When the duct 34 is supplied with fluid under the membrane 30, the membrane 30 of elastomer material expands radially and comes, under pressure, into contact with the inner surface 22a of the cross-beam 2. The presence of the holes 10 does not pose a problem for the use of the mechanical device owing to the presence of the membrane 30.

When the pressure in the supply duct 34 is removed, the mechanical device 26 again takes up, by resilient return of the membrane, the radially restricted state thereof having a cross-section smaller than that of the inner surface 22a.

FIGS. 7 and 8 illustrate a mechanical device 36 which comprises resiliently deformable annular elements 42 which are engaged around a shaft 38 having a first end 38a and a second end 38b. The shaft 38 is provided at the first end 38a with a shoulder 40. The annular elements 42 are separated from each other by shims 44. As illustrated in FIG. 6, in the absence of any stress applied to the annular elements 42, they have an inside diameter which is substantially equal to the outside diameter of the shaft and a concave outer surface 42a.

In order to bring the mechanical device 36 into the radially expanded state thereof, as illustrated by the arrow 45, a tensile force is applied to the second end 38b of the shaft 38 so that the annular elements 42 are axially compressed between the shims 44 and the shoulder 40. Under the effect of the axial stress resulting from the tensile force applied to the shaft 38, the annular elements 42 expand radially.

In order to obtain a relatively uniform distribution of the pressure applied by the annular elements 42 to the inner surface 22a of the cross-beam 2, the surface of the annular elements which is intended to come into contact with the inner surface 22a of the cross-beam is to be machined to the desired cylindrical shape, in this case having a circular cross-section, after the device has been brought into the radially expanded state thereof.

The annular elements 42 are preferably produced from thermoplastic elastomer material, in particular polyurethane elastomer, such as ELADIP (trade name).

FIGS. 8 to 10 illustrate a mechanical device 46 which comprises a sheath 48, around which metal sleeves 50 having a frustoconical cross-section and metal split rings 52 having a complementary cross-section are arranged in alternating succession.

The sheath 48 comprises a head 47 and is connected to a threaded end piece 49 by means of a screw 54. The head 47 and the end piece 49 each have a bevelled surface 47a, 49a which comes into contact with a split ring 52.

By the screw 54 being tightened, a load is applied in the axial direction 8 between the sleeves 50 and the split rings 52. As illustrated in FIG. 10, owing to the above-mentioned shapes of the split rings and the sleeves, the sleeves 50 tend to move under the split rings 52 and open them. The split rings change in this manner from a cross-section smaller than that of the passage 18 to a substantially equal cross-section so that the split rings 52 apply a pressure by means of the outer surface 52a thereof to the inner surface 22a of the cross-beam.

By the screw 54 being loosened, the split rings 52 resiliently return from the radially expanded state thereof to a radially restricted state.

FIGS. 11 to 13 illustrate a mechanical device 56 which comprises a rod 58 and elements having a circular cross-section, here spheres 60, which are secured inside housings 62 which are arranged in a tubular cage 64 having an inner passage 65. In this manner, the spheres 60 are arranged in an annular manner. The cage 64 comprises two tubular elements 64a, 64b which are fixed to each other. The spheres 60 have a small degree of freedom of displacement perpendicular to the axial direction 8 inside the housings 62.

In this manner, it is readily possible to insert the cage 64 carrying the spheres 60 into the passage 18 which is arranged in the cross-beam through the openings 20a, 20b. Next, the rod 58 is inserted into the inner passage 65. The cross-section of the rod 68 is such that it causes the spheres 60 to move radially and to apply a pressure to the inner surface 22a of the cross-beam.

Owing to the quasi-point-like contacts between the spheres 60 and the rod 58 and the shape of the spheres 60, the rod 58 can move relative to the spheres by means of rolling. The introduction and the withdrawal of the rod 58 inside the inner passage 65 therefore requires only a moderate effort relative to the pressure applied by the spheres 60 to the inner surface 22a of the cross-beam 2.

FIGS. 14 to 16 illustrate a mechanical device 76 comprising a tubular structure 78 which extends between a proximal end 75 and a distal end 77 in an axial direction 8 and which is secured at each end on an end piece 73a, 73b and which is protected by a protective sheath 70. In order to prevent the structure 78 from freeing itself from the end pieces 73a, 73b, the mechanical device 76 further comprises a securing ring 72 at each end.

The structure 78 comprises metal reinforcing strands 78a, 78b which are wound in a helix and which are embedded in a plastics sleeve 78c. First metal strands having a relatively fine diameter constitute a first winding 78a and second metal strands having, relatively, a greater diameter constitute a second winding 78b which covers the first winding 78a. The plastics sleeve 78c which is relatively rigid and strong ensures the securing of the metal strands and the leak-tightness of the structure 78.

In this manner, the structure 78 is hermetic and self-supporting. The sheath 70 protects the structure 78 from the imperfections which the inner surface 22a of the cross-beam has, such as burrs or holes 10. In particular, it can be constituted by a layer of rubber, elastomer or by a woven metal material.

The mechanical device 76 is secured on the shank of the jack 16 only at the proximal end 75 thereof (the distal end 77 being free) and by fixing means 79. These fixing means are constituted here by a thread which is produced in the sleeve 73b and which co-operates with a thread produced on the shank of the jack 16. Any other similar fixing means or any other flanging means would also be suitable.

Since the structure 78 is self-supporting, though secured in an overhanging arrangement only at the proximal end 75 thereof, the mechanical device 76 remains rectilinear in the axial direction 8.

The mechanical device 76 further comprises a supply duct for pressurised fluid which opens into a space 80 which extends inside the structure 78. When the duct 74 is supplied with fluid under high pressure (approximately 200 bar), the hermetic structure 78 and the protective sheath 70 expand radially and come, under pressure, into contact with the inner surface 22a of the cross-beam 2. Owing to the rigidity of the structure 78, the holes 10 do not affect the efficacy of the mechanical device 76.

When the pressure decreases in the supply duct 74, by resilient return, the hermetic structure 78 and the protective sheath 70 return to the radially restricted state thereof having a cross-section smaller than the inner surface 22a.

Naturally, the invention is in no way limited to the construction which has been described above by way of nonlimiting example. In this manner, instead of having a circular cross-section, the passage 18 could be rectangular or even of any shape. It would then be possible to provide elements having a circular cross-section which are not spherical, such as, for example, rollers.

1. Method for over-moulding an at least partially tubular element, which has an inner surface and which extends in an extension direction, by compression of plastics material, the method comprising the following steps:
a) using a mechanical device which extends between a proximal end and a free end and which has a radially restricted state and a radially expanded state, the device having a rigidity such that it extends in the radially restricted state thereof in a substantially rectilinear axial direction and keeps this shape of itself,
b) bringing the mechanical device into the radially restricted state thereof, in which it has a cross-section smaller than that of the inner surface of the tubular element,
c) securing the mechanical device at the proximal end thereof and introducing the mechanical device inside the tubular element by translation in the extension direction,
d) bringing the mechanical device, in the radially expanded state thereof, into contact, under pressure, with the inner surface of the tubular element,
e) after the mechanical device, the tubular element and the plastics material have been arranged inside a mould, closing the mould in order to compress the plastics material.

2. Method according to claim 1, wherein:
the mechanical device is provided with a structure comprising reinforcing strands, a resiliently deformable hermetic casing and means for supplying the casing with pressurised fluid,
during step d), the pressurised fluid is introduced into the hermetic casing.

3. Method according to claim 1, wherein:
the mechanical device is provided with a hermetic casing which surrounds a shaft and means for supplying the casing with pressurised fluid,
during step d), the pressurised fluid is introduced into the hermetic casing.

4. Method according to claim 1, characterised in that:
the device is provided with annular means which are radially expansible resiliently under the action of an axial stress and means for axially compressing the annular means,
during step d), the annular means are axially compressed.

5. Method according to claim 1, wherein:
the device is provided with radially movable elements which have a circular cross-section and which are arranged in an annular arrangement having an annular passage,
the device is provided with a rod having a cross-section greater than the cross-section of the annular passage and,
during step d), the rod is engaged in the annular passage in order to displace the circular elements radially.

6. Method according to claim 1, wherein:
the tubular element has a first opening and a second opening which are arranged at each end of the tubular element in the extension direction and,
during step c), a first mechanical device is introduced through the first opening by translation in the extension direction, with the device being secured at the proximal end thereof, and a second mechanical device is introduced through the second opening by translation in the extension direction, with the device also being secured at the proximal end thereof.

7. Assembly for over-moulding an at least partially tubular element, which has an inner surface and which extends in an extension direction, by compression of plastics material, the assembly comprising a mould and a mechanical device which extends between a proximal end and a free end and which has a radially restricted state and a radially expanded state, the device having, in the radially restricted state thereof, a cross-section smaller than that of the inner surface of the tubular element and, in the radially expanded state thereof, a cross-section greater than or equal to that of the inner surface of the tubular element, wherein:
the mechanical device has a rigidity such that it extends in a substantially rectilinear axial direction between the proximal end and the free end and keeps this shape of itself,
the assembly comprises means for displacing the mechanical device in the extension direction, the means securing the mechanical device only at the proximal end thereof.

8. Assembly according to claim 7, wherein the device comprises a structure formed by reinforcing strands, a hermetic casing and means for supplying the casing with pressurised fluid.

9. Assembly according to claim 7, wherein the device comprises a shaft, a hermetic casing and means for supplying the casing with pressurised fluid.

10. Assembly according to claim 7, wherein the device comprises:
annular means which are radially expansible resiliently under the action of an axial stress, and
means for axially compressing the annular means.

11. Assembly according to claim 10, wherein the annular means are of elastomer material and have an outer surface which is completely cylindrical when the mechanical device is in the radially expanded state thereof and slightly concave when the mechanical device is in the radially restricted state thereof.

12. Assembly according to claim 10, wherein the annular means comprise a split ring and a sleeve which are both of metal, the sleeve having radially a cross-section forming a truncated cone so that, under the action of the means for axially compressing the annular means, the sleeve comes into contact with the ring, is inserted under the split ring and opens it.

13. Assembly according to claim 7, wherein the device further comprises:
radially movable circular elements, which are arranged in an annular arrangement having an annular passage, and
a rod which engages in the annular passage in order to displace the circular elements radially.

14. Assembly according to claim 13, wherein the circular elements are defined by spheres or rollers which are secured relative to each other by a tubular cage.
